(19) United States
(12) Patent Application Publication
(10) Pub. No.: US 2020/0184963 A1
(43) Pub. Date: Jun. 11, 2020

(54) VIRTUAL ASSISTANT AUGMENTATION SYSTEM

(71) Applicant: AT&T Intellectual Property I, L.P., Atlanta, GA (US)

(72) Inventors: Kurt M. Joseph, Austin, TX (US); Di Liu, Redmond, WA (US); Marian Sweeney-Dillon, Austin, TX (US)

(21) Appl. No.: 16/213,529

(22) Filed: Dec. 7, 2018

(51) Int. Cl. G10L 15/22; G10L 15/30

(52) U.S. Cl. CPC G10L 15/22; G10L 2015/228; G10L 2015/223; G10L 15/30

(57) ABSTRACT

Systems and methods for providing an audio communication system include determining content factors of content to be presented to a user participating in a virtual assistant interaction session between a user and a virtual assistant provided through a voice-controlled device. Context factors associated with a physical environment in which the voice-controlled device and the user are located are also determined and computing devices coupled to the voice-controlled device are identified. Each of the at least one computing device provides a respective device capability. In response to the content factors, the context factors, and the respective device capabilities of each at least one computing device satisfying a first virtual assistant augmentation condition, at least a portion of the content of the virtual assistant interaction session is transferred to a first computing device of the at least one computing device and presented to the user by the first computing device.

### BACKGROUND

### Field of the Disclosure

The present disclosure generally relates to virtual assistants and more particularly to augmenting virtual assistant interaction sessions.

### Related Art

Homes and other environments are being “automated” with the introduction of interconnected computing devices that perform various tasks. Many of these computing devices are voice-controlled such that a user may interact with the voice-controlled devices via speech. The voice-controlled devices may capture spoken words and other audio input through a microphone, and perform speech recognition to identify audio commands within the audio inputs. Using artificial intelligence, such as virtual assistants, the voice-controlled devices may perform various tasks based on the voice commands and provide responses to the audio commands from the user via a speaker system. For example, a voice-controlled device, via the virtual assistant, may then use the voice commands to purchase items and services over electronic networks, obtain information, provide media content, provide communications between users, provide customer service support, and the like. However, interacting with a virtual assistant through a voice-controlled device that provides an auditory-only channel is limited in that more complex tasks cannot be completed by the voice-controlled computing devices or are completed inefficiently.

### BRIEF DESCRIPTION OF THE FIGURES

FIG. 1 is a schematic view illustrating an embodiment of a virtual assistant augmentation system;

FIG. 2 is a schematic view illustrating an embodiment of a voice-controlled device in the virtual assistant augmentation system of FIG. 1;

FIG. 3 is a schematic view illustrating an embodiment of a virtual assistant augmentation server in the virtual assistant augmentation system of FIG. 1;

FIG. 4 is a schematic view illustrating an embodiment of a user device/auxiliary device in the virtual assistant augmentation system of FIG. 1;

FIG. 5 is a flow chart illustrating an embodiment of a method of virtual assistant augmentation;

FIG. 6A is a block diagram illustrating an embodiment of an example use of the virtual assistant augmentation system of FIG. 1;

FIG. 6B is a block diagram illustrating an embodiment of an example use of the virtual assistant augmentation system of FIG. 1;

FIG. 7 is a schematic view illustrating an embodiment of a computer system; and

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### SUMMARY

Embodiments of the present disclosure describe systems and methods that provide for a virtual assistant augmentation system. The virtual assistant augmentation system and methods provide for presenting content of a virtual assistant interaction session to a user via an output interface on a computing device other than a voice-controlled device with which the virtual assistant interaction is initiated that is better able to provide the content than the output interface(s) that are included on the voice-controlled device. The virtual assistant interaction session is augmented based on content factors associated with the content that is to be presented to the user, context factors associated with the physical environment in which the voice-controlled device is located and/or the user, and device capabilities of computer devices that may be used as auxiliary devices in conducting the virtual assistant interaction session that provide alternative output interfaces for the content.

In some embodiments in accordance with the present disclosure, a method of virtual assistant augmentation is disclosed. During the method, content factors of content to be presented to a user participating in a virtual assistant interaction session between the user and a virtual assistant provided through a voice-controlled device are determined. Also, context factors associated with a physical environment in which the voice-controlled device and the user are located are determined. At least one computing device coupled to the voice-controlled device is identified. Each of the at least one computing device provides a respective device capability. In response to the content factors, the context factors, and the respective device capabilities of each at least one computing device satisfying a first virtual assistant augmentation condition, at least a portion of the content of the virtual assistant interaction session is transitioned to a first computing device of the at least one computing device.

In various embodiments of the method in response to the content factors, the context factors, and the respective device capabilities of each at least one computing device satisfying a second augmentation condition, the virtual assistant interaction session transitions to a second computing device of the at least one computing device.

In various embodiments of the method the virtual assistant interaction session transitions back to the voice-controlled device in response to completion of the at least the portion of the virtual assistant interaction session at the first computing device.

In various embodiments of the method a machine learning algorithm is used to predict acceptable transitions between the voice-controlled device and the first computing device of the at least one computing device.

In various embodiments of the method a determination that the virtual assistant interaction session is interrupted is made, and a reminder by the first computing device of the at least one computing device that the virtual assistant interaction session is incomplete is provided to the user.

In various embodiments of the method the voice-controlled device does not include an output device that is configured to service the at least the portion of the content.

In various embodiments of the method the content factors include at least one of a privacy level, a content type, a security level, an authentication requirement, and informational context of the content and the context factors include at least one of location information of the voice-controlled device, movement information of the user within the physical environment, and presence information of additional users.

In various embodiments of the method an audio input is received at the voice-controlled device that includes an audio command that initiates the virtual assistant interaction session.

In various embodiments of the method the user participating in the virtual assistant interaction session is identified. The first virtual assistant augmentation condition is based on an identity of the user.

In some embodiments in accordance with the present disclosure, a virtual assistant augmentation system is disclosed. The system includes a non-transitory memory, and one or more hardware processors coupled to the non-transitory memory and configured to read instructions from the non-transitory memory to cause the system to perform operations. The operations include: determining content factors of content to be presented to a user participating in a virtual assistant interaction session between the user and a virtual assistant provided through a voice-controlled device; determining context factors associated with a physical environment in which the voice-controlled device and the user are located; identifying at least one computing device coupled to the voice-controlled device, wherein each of the at least one computing device provides a respective device capability; and in response to the content factors, the context factors, and the respective device capabilities of each at least one computing device satisfying a first virtual assistant augmentation condition, transitioning at least a portion of the content of the virtual assistant interaction session to a first computing device of the at least one computing device.

In various embodiments of the virtual assistant augmentation system the operations further include in response to the content factors, the context factors, and the respective computing device capabilities of each at least one device satisfying a second augmentation condition, transitioning the virtual assistant interaction session to a second computing device of the at least one computing device.

In various embodiments of the virtual assistant augmentation system the operations further include transitioning the virtual assistant interaction session back to the voice-controlled device in response to completion of the at least the portion of the virtual assistant interaction session at the first computing device.

In various embodiments of the virtual assistant augmentation system the operations further include predicting, using a machine learning algorithm, acceptable transitions between the voice-controlled device and the first computing device of the at least one computing device.

In various embodiments of the virtual assistant augmentation system the operations further include determining that the virtual assistant interaction session is interrupted; and providing a reminder by the first computing device that the virtual assistant interaction session is incomplete.

In some embodiments in accordance with the present disclosure, a non-transitory machine-readable medium having stored thereon machine-readable instructions executable to cause a machine to perform operations. The operations include: determining content factors of content to be presented to a user participating in a virtual assistant interaction session between the user and a virtual assistant provided through a voice-controlled device; determining context factors associated with a physical environment in which the voice-controlled device and the user are located; identifying at least one computing device coupled to the voice-controlled device, wherein each of the at least one computing device provides a respective device capability; and in response to the content factors, the context factors, and the respective device capabilities of each at least one computing device satisfying a first virtual assistant augmentation condition, transitioning at least a portion of the content of the virtual assistant interaction session to a first computing device of the at least one computing device.

In various embodiments of the virtual assistant augmentation system the operations further include, in response to the content factors, the context factors, and the respective computing device capabilities of each at least one device satisfying a second augmentation condition, transitioning the virtual assistant interaction session to a second computing device of the at least one computing device.

In various embodiments of the virtual assistant augmentation system the operations further include transitioning the virtual assistant interaction session back to the voice-controlled device in response to completion of the at least the portion of the virtual assistant interaction session at the first computing device.

In various embodiments of the virtual assistant augmentation system the operations further include predicting, using a machine learning algorithm, acceptable transitions between the voice-controlled device and the first computing device of the at least one computing device.

In various embodiments of the virtual assistant augmentation system the operations further include determining that the virtual assistant interaction session is interrupted; and providing a reminder by the first computing device that the virtual assistant interaction session is incomplete.

### DETAILED DESCRIPTION

Virtual Assistants (VAs) are rising in popularity as a new channel of communication between customers and businesses. They offer several advantages over traditional channels; for instance, 24/7 availability and the capability to provide personalized solutions. Given the major constraints associated with using an auditory-only channel through some voice-controlled devices to communicate with a virtual assistant to facilitate and/or support complex tasks and multi-tasking, creative ways to present information to users need to be considered. Also, as users may be inclined to communicate with the virtual assistant while on the move, transitioning from the voice-controlled device to another (e.g., taking a virtual assistant interaction session from a voice-controlled device to a connected car) and from one modality to another (e.g., auditory to auditory-visual) may be beneficial.

The present disclosure provides a virtual assistant augmentation system and method for augmenting virtual assistant interaction sessions. The virtual assistant augmentation system may classify the content of a virtual assistant interaction session being conducted on a voice-controlled device between a virtual assistant and a user, classify context of a physical environment in which the voice-controlled device and the user are located, and gather device capabilities of a user device and/or an auxiliary device that are present in the physical environment other than the voice-controlled device. The virtual assistant augmentation system may use context factors, content factors, and the device capabilities to determine whether to augment the virtual assistant interaction session by presenting a portion of the content at the user device and/or the auxiliary device when the virtual assistant device does not have the device capabilities to present the content (e.g., visual content may be displayed at a display screen of the user device and/or the auxiliary device), and/or audio content is sensitive requiring a more private virtual assistant interaction session than what can be provided by the voice-controlled device in the physical environment.

As such, the virtual assistant augmentation system described herein provides benefits for a user conversing on an auditory/speech only platform provided by a voice-controlled device during a virtual assistant interaction session by having additional informational cues added to their virtual assistant interaction session via a secondary platform (e.g., haptic, visual, olfactory, multimodal) on a user device and/or auxiliary device. A user on an auditory/speech-only voice-controlled device can benefit from leveraging a secondary platform to help them process complex information or with multi-tasking (e.g., calendar, map, more than one task, etc.) during the virtual assistant interaction session. Once the task that used the secondary platform on the user device and/or the auxiliary device is completed, the user that is on the secondary visual platform can benefit from moving back to a more mobile, auditory/speech-only platform that requires less attentional resources when visual information is no longer required in a task. Rules can be used to set preferences for controlling content, context, and the timing of transitions to a secondary platform. Also, the system can flexibly and dynamically support tasks, allowing the user to move through the physical environment and process information more naturally.

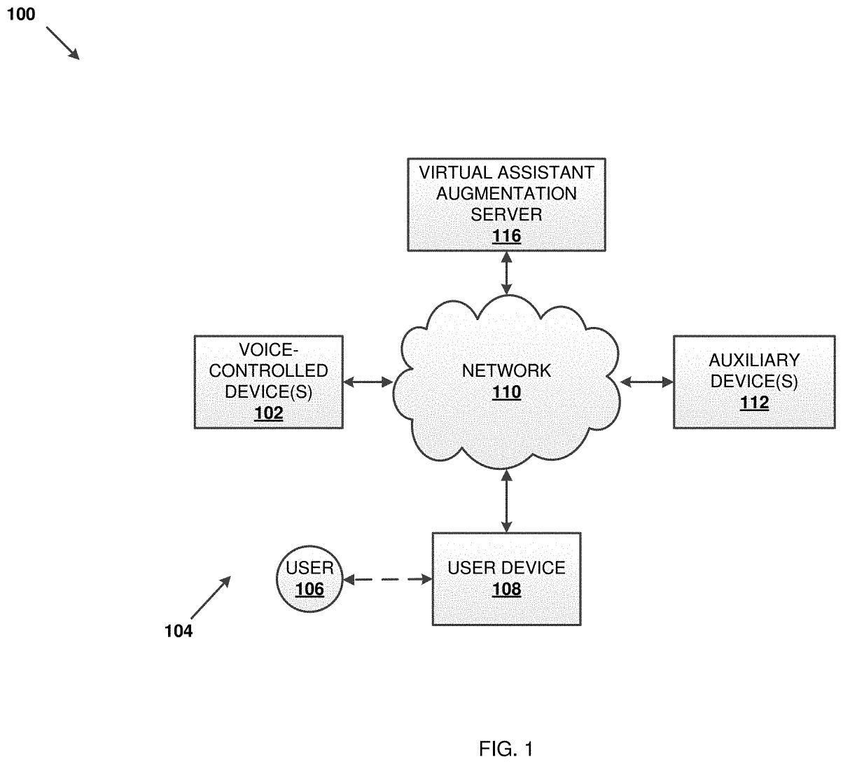

Referring now to FIG. 1, an embodiment of a virtual assistant augmentation system 100 is illustrated. In an embodiment, the virtual assistant augmentation system 100 may include a voice-controlled device 102, a user device 108, an auxiliary device 112, and a virtual assistant augmentation server 114 coupled via a network 110. The voice-controlled device 102, the user device 108, and the auxiliary device 112 may be provided in a physical environment 104. The physical environment 104 may be any indoor and/or outdoor space that may be contiguous or non-contiguous. For example, the physical environment 104 may include a yard, a home, a business, a park, a stadium, a museum, an amusement park, an access space, an underground shaft, or other spaces. The physical environment 104 may be defined by geofencing techniques that may include specific geographic coordinates such as latitude, longitude, and/or altitude, and/or operate within a range defined by a wireless communication signal.

In various embodiments, virtual assistant augmentation system 100 includes the voice-controlled device 102. While a single voice-controlled device 102 is illustrated in FIG. 1, the virtual assistant augmentation system 100 may include any number of voice-controlled devices. The voice-controlled device 102 may include computing devices that do not provide a visually-based user interface for communication between a user 106 and a virtual assistant, described in more detail below. For example, the voice-controlled device 102 may include computing devices that only provided an audio-based user interface. However, in other embodiments, the voice-controlled device 102 may include other user interface such as, for example, a haptic feedback-based user interface, an olfactory-based user interface and/or other output device technology for use in outputting information to the user 106.

In various embodiments, the virtual assistant augmentation system 100 may include the user device 108. While one user device 108 is illustrated in FIG. 1, the virtual assistant augmentation system 100 may include any number of user devices that each may be associated with one or more users. The user device 108 may include a mobile computing device such as a laptop/notebook computing device, a tablet computing device, a mobile phone, a wearable computing device, and/or any other mobile computing device that would be apparent to one of skill in the art in possession of the present disclosure. However, in other embodiments, the user device 108 may be provided by a desktop computing device, a server computing device, Internet of Thing (IoT) devices, and/or a variety of other computing devices that would be apparent to one of skill in the art in possession of the present disclosure.

In various embodiments, the virtual assistant augmentation system 100 may include the auxiliary device 112. While one auxiliary device 112 is illustrated in FIG. 1, the virtual assistant augmentation system 100 may include any number of auxiliary devices. The auxiliary device 112 may be provided by computing devices that include a visually-based user interface for providing information to the user 106. However, in other embodiments, the auxiliary device 112 may include at least one type of user interface for outputting information that is not included in the voice-controlled device 102. For example, the auxiliary device 112 may be provided by the user device 108, and as such, the auxiliary device 112 may be provided by a laptop/notebook computing device, a tablet computing device, a mobile phone, a wearable computing device, a desktop computing device, a server computing device, a television, an Internet of Things (IoT) device (e.g., a vehicle, a home appliance, etc.), and/or a variety of other computing devices that would be apparent to one of skill in the art in possession of the present disclosure. While the virtual assistant augmentation system 100 in FIG. 1 illustrates an auxiliary device 112 and a user device 108, one of skill in the art would recognize that the physical environment 104 may include only a user device 108 or may include only an auxiliary device 112.

In various embodiments, the virtual assistant augmentation system 100 also includes or may be in communication with the virtual assistant augmentation server 114. For example, the virtual assistant augmentation server 114 may include one or more server devices, storage systems, cloud computing systems, and/or other computing devices (e.g., desktop computing device(s), laptop/notebook computing device(s), tablet computing device(s), mobile phone(s), etc.). As discussed below, the virtual assistant augmentation server 114 may provide a virtual assistant augmentation service that is configured to perform the functions of the virtual assistant augmentation service and/or virtual assistant augmentation server discussed below. The virtual assistant augmentation server 114 may also provide a virtual assistant that is configured to perform the function of the virtual assistant discussed below. However, in other embodiments the virtual assistant may be provided by another service provider on a separate server.

The voice-controlled device 102, the user device 108, and the auxiliary device 112 may include communication units having one or more transceivers to enable the voice-controlled device 102, the user device 108, and the auxiliary device 112 to communicate with other devices in the virtual assistant augmentation system 100 via a network 110 or through a peer-to-peer connection. Accordingly and as disclosed in further detail below, the voice-controlled device 102, the user device 108, and/or the auxiliary device 112 may be in communication with each other directly or indirectly. As used herein, the phrase “in communication,” including variances thereof, encompasses direct communication and/or indirect communication through one or more intermediary components and does not require direct physical (e.g., wired and/or wireless) communication and/or constant communication, but rather additionally includes selective communication at periodic or aperiodic intervals, as well as one-time events.

For example, the voice-controlled device 102, the user device 108, and/or the auxiliary device 112 in the virtual assistant augmentation system 100 of FIG. 1 may include first (e.g., long-range) transceiver(s) to permit the voice-controlled device 102, the user device 108, and/or the auxiliary device 112 to communicate with the network 110. The network 110 may be implemented by an example mobile cellular network, such as a long-term evolution (LTE) network or other third-generation (3G), fourth-generation (4G) wireless network, or fifth-generation (5G) wireless network. However, in some examples, the network 110 may be additionally or alternatively implemented by one or more other communication networks, such as, but not limited to, a satellite communication network, a microwave radio network, and/or other communication networks.

The voice-controlled device 102, the user device 108, and/or the auxiliary device 112 additionally may include second (e.g., short-range) transceiver(s) to permit the voice-controlled device 102, the user device 108, and/or the auxiliary device 112 to communicate with each other via a direct communication channel. In the illustrated example of FIG. 1, such second transceivers are implemented by a type of transceiver supporting short-range (i.e., operate at distances that are shorter than the long-range transceivers) wireless networking. For example, such second transceivers may be implemented by Wi-Fi transceivers (e.g., via a Wi-Fi Direct protocol), Bluetooth® transceivers, infrared (IR) transceiver, and other transceivers that are configured to allow the voice-controlled device 102, the user device 108, and/or the auxiliary device 112 to intercommunicate via an ad-hoc or other wireless network.

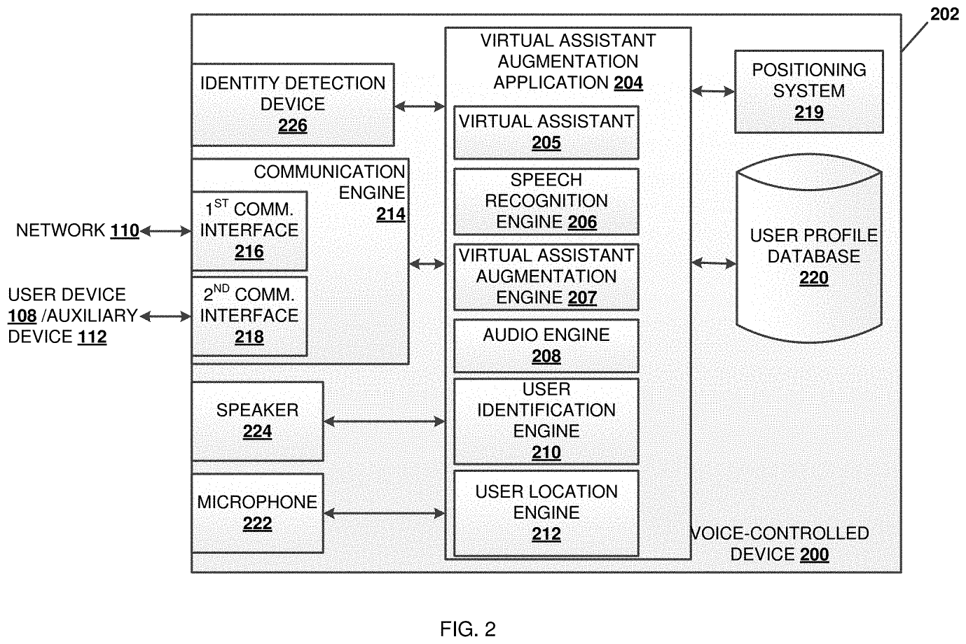

Referring now to FIG. 2, an embodiment of a voice-controlled device 200 is illustrated that may be the voice-controlled device 102 discussed above with reference to FIG. 1, and which may include a voice-enabled wireless speaker system, a home appliance, a desktop computing system, a laptop/notebook computing system, a tablet computing system, a mobile phone, a set-top box, a vehicle audio system, and/or other voice-controlled devices known in the art. In the illustrated embodiment, the voice-controlled device 200 includes a chassis 202 that houses the components of the voice-controlled device 200, only some of which are illustrated in FIG. 2. For example, the chassis 202 may house a processing system (not illustrated) and a non-transitory memory system (not illustrated) that includes instructions that, when executed by the processing system, cause the processing system to provide a virtual assistant augmentation application 204 that is configured to perform the functions of the virtual assistant augmentation applications and/or the voice-controlled devices 200 discussed below. In the specific example illustrated in FIG. 2, the virtual assistant augmentation application 204 is configured to provide a virtual assistant 205, a speech recognition engine 206, a virtual assistant augmentation engine 207, an audio engine 208, a user identification engine 210, and a user location engine 212 that perform the functionality discussed below, although one of skill in the art in possession of the present disclosure will recognize that other applications and computing device functionality may be enabled by the application engine 204 as well. While the virtual assistant augmentation application 204 has been illustrated as housed in the chassis 202 of the voice-controlled device 200, one of skill in the art will recognize that some of the functionality of the virtual assistant augmentation application 204 may be provided by a virtual assistant service and/or a virtual assistant augmentation service that is provide by the virtual assistant augmentation server 116 via the network 110 without departing from the scope of the present disclosure. Also, while the following disclosure describes virtual assistants, it is contemplated that the virtual assistants described herein may be replaced with a chatbot.

The chassis 202 may further house a communication engine 214 that is coupled to the virtual assistant augmentation application 204 (e.g., via a coupling between the communication engine 214 and the processing system). The communication engine 214 may include software or instructions that are stored on a computer-readable medium and that allow the voice-controlled device 200 to send and receive information over the networks discussed above. For example, the communication engine 214 may include a first communication interface 216 to provide for communications through the network 110 of FIG. 1 as detailed below. In an embodiment, the first communication interface 216 may be a wireless antenna that is configured to provide communications with IEEE 802.11 protocols (Wi-Fi). In other examples, the first communication interface 216 may provide wired communications (e.g., Ethernet protocol) from the voice-controlled device 200 and through the network 110. The communication engine 214 may also include a second communication interface 18 that is configured to provide direct communication with user device 108, the auxiliary device 112, and/or other voice-controlled devices. For example, the second communication interface 218 may be configured to operate according to wireless protocols such as Bluetooth®, Bluetooth® Low Energy (BLE), near field communication (NFC), infrared data association (IrDA), ANT, Zigbee, and other wireless communication protocols that allow for direct communication between devices.

The chassis 202, in some embodiments, may also include a positioning system 219 that is coupled to the virtual assistant augmentation application 204. The positioning system 219 may include sensors for determining the location and position of the voice-controlled device 200 in the physical environment 104. For example, the positioning system 219 may include a global positioning system (GPS) receiver, a real-time kinematic (RTK) GPS receiver, a differential GPS receiver, a Wi-Fi based positioning system (WPS) receiver, an accelerometer, a gyroscope, any other sensor for detecting and/or calculating the orientation and/or movement, and/or other positioning systems and components.

The chassis 202 may also house a user profile database 220 that is coupled to the virtual assistant augmentation application 204 through the processing system. The user profile database 220 may store user profiles that include user information, user preferences, user device identifiers, contact lists, and/or other information used by the virtual assistant augmentation application 204 to determine an identity of a user interacting with or in proximity of the voice-controlled device 200, to augment a virtual assistant session, and/or to perform any of the other functionality discussed below. While the user profile database 220 has been illustrated as housed in the chassis 202 of the voice-controlled device 200, one of skill in the art will recognize that it may be connected to the virtual assistant augmentation application 204 through the network 110 without departing from the scope of the present disclosure.

The chassis 202 may also house a microphone 222, a speaker 224, and in some embodiments, an identity detection device 226. For example, the microphone 222 may include an array of microphones that are configured to capture sound from the physical environment 104, and generate audio signals to be processed. The array of microphones may be used to determine a direction of a user speaking to the voice-controlled device 200. Similarly, the speaker 224 may include an array of speakers that are configured to receive audio signals from the audio engine 208, and output sound to the physical environment 104. The array of speakers may be used to output sound in the direction of the user 106 speaking to the voice-controlled device 200. The identity detection device 226 may be a camera, a motion sensor, a thermal sensor, a fingerprint scanner, and/or any other device that may be used to gather information from a surrounding location of the voice-controlled device 200 for use in identifying a user. The identity detection device 226 may be used by the user identification engine 210 and user location engine 212 to identify users and determine positions of users in relation to the voice-controlled device 200. While a specific example of the voice-controlled device 200 is illustrated, one of skill in the art in possession of the present disclosure will recognize that a wide variety of voice-controlled devices having various configurations of components may operate to provide the systems and methods discussed herein without departing from the scope of the present disclosure. For example and as discussed above, the voice-controlled device 200 may not provide a visually-based user interface for communication between the user 106 and a virtual assistant or the visually-based user interface may be inactive or disabled. For example, the voice-controlled device 200 may provide an audio-based user interface, a haptic feedback based user interface, and/or other output device technology for use in outputting information to the user 106 other than a visually-based user interface. As such, the voice-controlled device 200 may include a first type user interface and not a second type user interface.

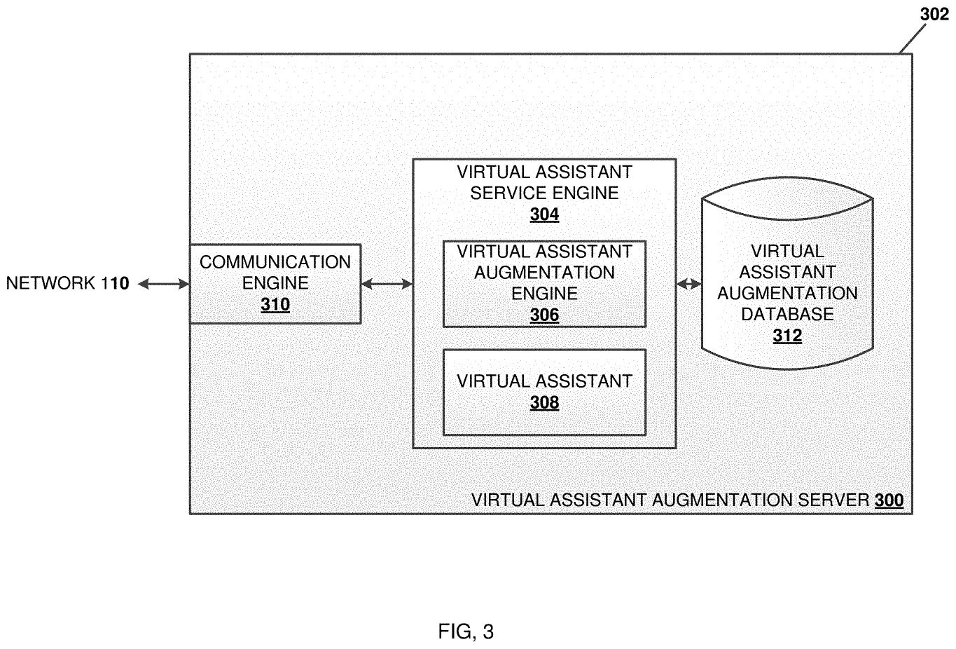

Referring now to FIG. 3, an embodiment of a virtual assistant augmentation server 300 is illustrated. In an embodiment, the virtual assistant augmentation server 300 may be the virtual assistant augmentation server 116 discussed above with reference to FIG. 1. In the illustrated embodiment, the virtual assistant augmentation server 300 includes a chassis 302 that houses the components of the virtual assistant augmentation server 300, only some of which are illustrated in FIG. 3. For example, the chassis 302 may house a processing system (not illustrated) and a non-transitory memory system (not illustrated) that includes instructions that, when executed by the processing system, cause the processing system to provide a virtual assistant service engine 304 that is configured to perform the functions of the virtual assistant service engines and/or the virtual assistant augmentation servers discussed below. In the specific example illustrated in FIG. 3, the virtual assistant service engine 304 is configured to provide a virtual assistant augmentation engine 306 and in some embodiments, a virtual assistant 308 that perform the functionality discussed below, although one of skill in the art in possession of the present disclosure will recognize that other applications and computing device functionality may be enabled by the virtual assistant service engine 304 as well. While the virtual assistant service engine 304 has been illustrated as housed in the chassis 302 of the virtual assistant augmentation server 300, one of skill in the art will recognize that some of the functionality of the virtual assistant service engine 304 may be provided by the virtual assistant augmentation application 204 of the voice-controlled device 200 and/or another server device without departing from the scope of the present disclosure. For example, the virtual assistant 308 may be provided by a third-party server that is in communication over the network 110 with the virtual assistant augmentation server 116. In a specific example, the virtual assistant service engine 304 may be configured to identify users, manage a virtual assistant session with a user, facilitate augmentation of virtual assistant session based on the content of the virtual assistant session and the context of the physical environment 104, and provide any of the other functionality that is discussed below.

The chassis 302 may further house a communication engine 310 that is coupled to virtual assistant service engine 304 (e.g., via a coupling between the communication engine 310 and the processing system) and that is configured to provide for communication through the network as detailed below. The communication engine 310 may allow virtual assistant augmentation server 300 to send and receive information over the network 110. The chassis 302 may also house a virtual assistant augmentation database 312 that is coupled to the virtual assistant service engine 304 through the processing system. The virtual assistant augmentation database 312 may store virtual assistant sessions, user profiles, user identifiers, virtual assistant augmentation rules, location information and capability information associated with the auxiliary device and the user device and/or other data used by the virtual assistant service engine 304 to provide virtual assistant augmentation to a virtual assistant session and/or provide a virtual assistant to one or more voice-controlled devices, user devices, and/or an auxiliary device. While the virtual assistant augmentation database 312 has been illustrated as housed in the chassis 302 of the virtual assistant augmentation server 300, one of skill in the art will recognize that the virtual assistant augmentation database 312 may be housed outside the chassis 302 and connected to the virtual assistant service engine 304 through the network 110 without departing from the scope of the present disclosure.

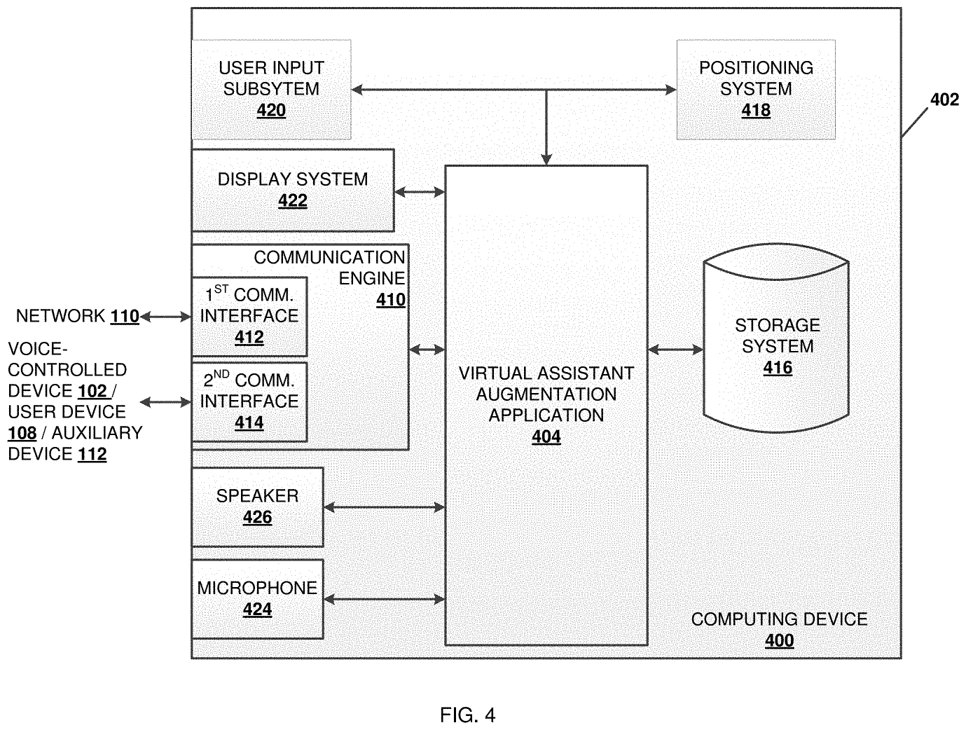

Referring now to FIG. 4, an embodiment of a computing device 400 is illustrated that may be the user device 108 or the auxiliary device 112 discussed above with reference to FIG. 1, and which may be provided by a mobile computing device such as a laptop/notebook computing device, a tablet computing device, a mobile phone, a wearable computing device, a desktop computing device, a server computing device, a television, an Internet of Things (IoT) device (e.g., a vehicle, a home appliance, etc.), and/or a variety of other computing devices that would be apparent to one of skill in the art in possession of the present disclosure. In the illustrated embodiment, the computing device 400 includes a chassis 402 that houses the components of the computing device 400. Several of these components are illustrated in FIG. 4. For example, the chassis 402 may house a processing system (not illustrated) and a non-transitory memory system (not illustrated) that includes instructions that, when executed by the processing system, cause the processing system to provide virtual assistant augmentation application 404 that is configured to perform the functions of the virtual assistant augmentation application, the user devices, and the auxiliary devices discussed below.

The chassis 402 may further house a communication system 410 that is coupled to the virtual assistant augmentation application 404 (e.g., via a coupling between the communication system 410 and the processing system). The communication system 410 may include software or instructions that are stored on a computer-readable medium and that allow the computing device 400 to send and receive information through the communication networks discussed above. For example, the communication system 410 may include a first communication interface 412 to provide for communications through the communication network 110 as detailed above (e.g., first (e.g., long-range) transceiver(s)). In an embodiment, the first communication interface 412 may be a wireless antenna that is configured to provide communications with IEEE 802.11 protocols (Wi-Fi), cellular communications, satellite communications, other microwave radio communications and/or communications. The communication system 410 may also include a second communication interface 414 that is configured to provide direct communication with other user devices, auxiliary device, sensors, storage devices, and other devices within the physical environment 104 discussed above with respect to FIG. 1 (e.g., second (e.g., short-range) transceiver(s)). For example, the second communication interface 414 may be configured to operate according to wireless protocols such as Bluetooth®, Bluetooth® Low Energy (BLE), near field communication (NFC), infrared data association (IrDA), ANT®, Zigbee®, Z-Wave® IEEE 802.11 protocols (Wi-Fi), and other wireless communication protocols that allow for direct communication between devices.

The chassis 402 may house a storage device (not illustrated) that provides a storage system 416 that is coupled to the virtual assistant augmentation application 404 through the processing system. The storage system 416 may store user profiles that include user information, user preferences, user device identifiers, contact lists, and/or other information used by the virtual assistant augmentation application 404 to augment a virtual assistant session and/or to perform any of the other functionality discussed below. While the storage system 416 has been illustrated as housed in the chassis 402 of the computing device 400, one of skill in the art will recognize that it may be connected to the virtual assistant augmentation application 404 through the network 110 without departing from the scope of the present disclosure.

The chassis 402, in some embodiments, may also include a positioning system 418 that is coupled to the virtual assistant augmentation application 404. The positioning system 418 may include sensors for determining the location and position of the computing device 400 in the physical environment 104. For example, the positioning system 418 may include a global positioning system (GPS) receiver, a real-time kinematic (RTK) GPS receiver, a differential GPS receiver, a Wi-Fi based positioning system (WPS) receiver, an accelerometer, a gyroscope, any other sensor for detecting and/or calculating the orientation and/or movement, and/or other positioning systems and components.

In various embodiments, the chassis 402 also houses a user input subsystem 420 that is coupled to the virtual assistant augmentation application 404 (e.g., via a coupling between the processing system and the user input subsystem 420). In an embodiment, the user input subsystem 420 may be provided by a keyboard input subsystem, a mouse input subsystem, a track pad input subsystem, a touch input display subsystem, a camera, a motion sensor, a thermal sensor, a fingerprint scanner, and/or any other device that may be used to gather information from a surrounding location of the voice-controlled device 200 for use in identifying a user or objects in the physical environment 104 and/or any other input subsystem. The chassis 402 also houses a display system 422 that is coupled to the virtual assistant augmentation application 404 (e.g., via a coupling between the processing system and the display system 422). In an embodiment, the display system 422 may be provided by a display device that is integrated into the computing device 400 and that includes a display screen (e.g., a display screen on a laptop/notebook computing device, a tablet computing device, a mobile phone, or wearable device), or by a display device that is coupled directly to the computing device 400 (e.g., a display device coupled to a desktop computing device by a cabled or wireless connection).

The chassis 402 may also house a microphone 424 and a speaker 426. For example, the microphone 424 may include an array of microphones that are configured to capture sound from the physical environment 104, and generate audio signals to be processed. The array of microphones may be used to determine a direction of a user that is speaking to the computing device 400. Similarly, the speaker 426 may include an array of speakers that are configured to receive audio signals from the virtual assistant augmentation application 404, and output sound to the physical environment 104. While a specific example of the computing device 400 (e.g., the user device 108 and/or the auxiliary device 112) is illustrated, one of skill in the art in possession of the present disclosure will recognize that a wide variety of computing devices having various configurations of components may operate to provide the systems and methods discussed herein without departing from the scope of the present disclosure. For example and as discussed above, the computing device 400 may not provide an audio-based user interface communication (e.g., the microphone 424 and/or the speaker 426) between the user 106 and the computing device 400. For example, the computing device 400 may provide a visually-based user interface, a haptic feedback based user interface, and/or other output device technology for use in outputting information to the user 106 other than an audio-based user interface. As such, the computing device 400 may include the second type user interface and not the first type user interface that is provided by the voice-controlled device 102. However, in other embodiments the computing device 400 may include the first type user interface and the second type user interface.

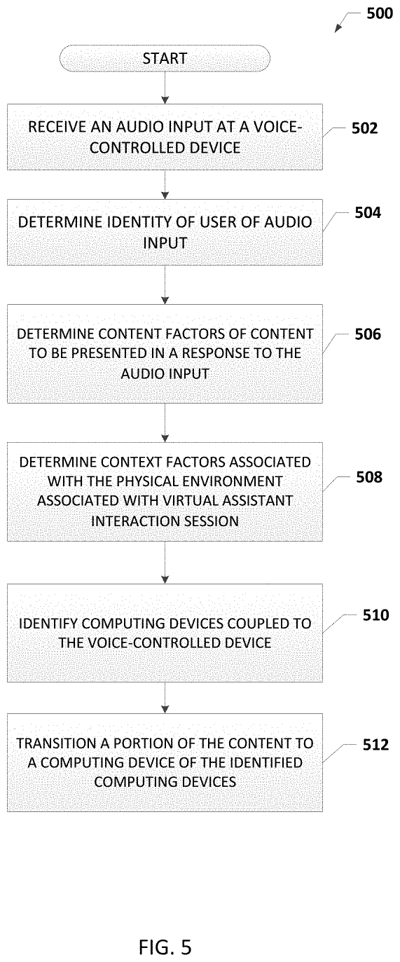

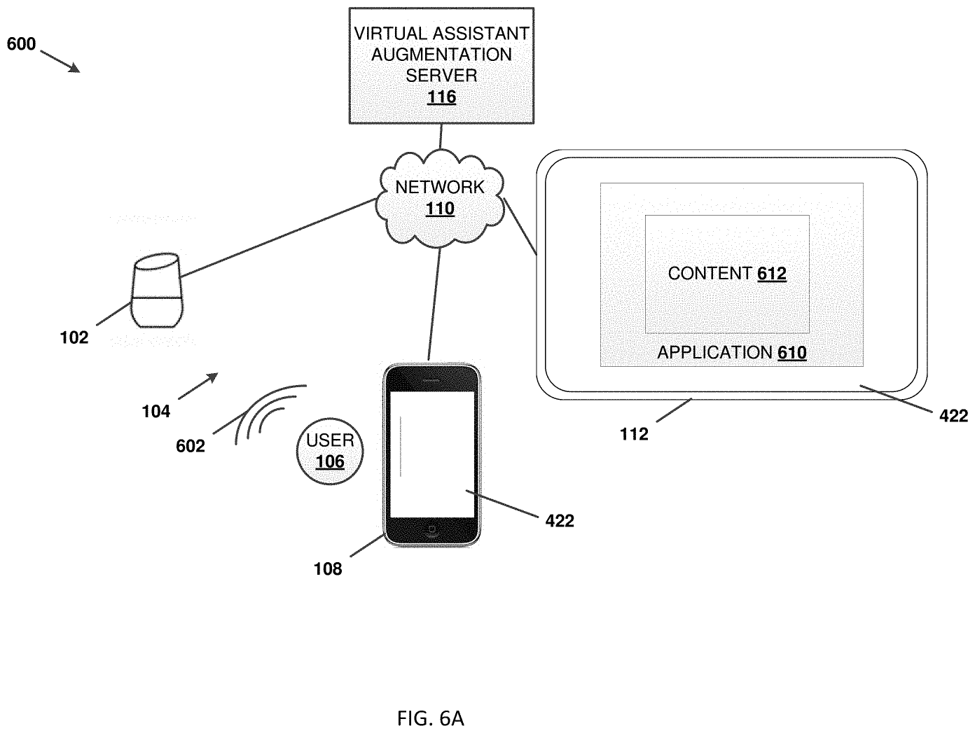

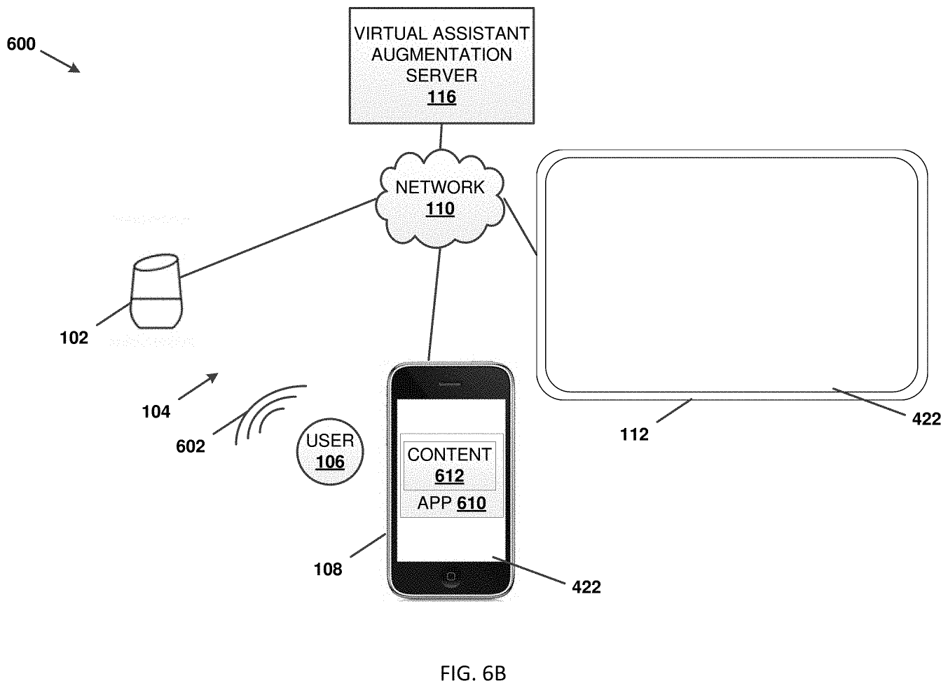

Referring now to FIG. 5, a method 500 of augmenting a virtual assistant interaction session is illustrated. The method 500 begins at block 502 where a voice-controlled device receives an audio input. In an embodiment of block 502, the voice-controlled device 102 may receive, via the microphone 222 that captures sound from the physical environment 104 and generates audio signals based on the captured sound, an audio signal from an audio input. The speech recognition engine 206 of a virtual assistant application engine may then analyze the audio signals generated from the sound of the audio input and further determine that audio input includes an audio command to the voice-controlled device 200. For example and with reference to the virtual assistant augmentation system 600 of FIGS. 6A and 6B, the user 106 may provide an audio input 602. The voice-controlled device 102 may capture the sound of the audio input 602 and convert the sound to audio signals that are then provided to the speech recognition engine 206 of the voice-controlled device 200. The speech recognition engine 206 may then analyze the audio signals and further determine that the audio input includes an audio command to the virtual assistant 205 (e.g., IBM Watson™, Inbenta™, Amazon Alexa™, Microsoft Cortana™, Apple Ski™, Google Assistant™, and/or other virtual assistant or chatbots that would be apparent to one of skill in the art in possession of the present disclosure) of the voice-controlled device 200. For example, the audio command may include a request for information, a command to perform an action, a response to a question, and/or other audio inputs that would be apparent to one of skill of art in possession of the present disclosure.

In a specific example, the user 106 may speak a predefined word or words, may make a predefined sound, or provide some other audible noise that, when recognized by the speech recognition engine 206, indicates to the speech recognition engine 206 that the user is going to provide an audio input to the voice-controlled device 200. The speech recognition engine 206 may determine that the audio input includes an audio command. The receiving of the audio command may initiate a virtual assistant interaction session. The virtual assistant interaction session may be series of interactions between the user 106 and the virtual assistant 205 that attempts to complete the audio command or a set of audio commands provided by the user 106 to the virtual assistant 205.

In various embodiments, the user device 108 and/or the auxiliary device 112 may contribute context of the physical environment 104 to the virtual assistant 205 with the audio command. For example, when an audio signal is processed by the virtual assistant 205 and the virtual assistant 205 determines that an audio command is present, the virtual assistant 205 may cause, through communication engines 214 and 410, the computing device 400 capture physical environment information via the user input subsystem 420 that can be used to determine an appropriate response to the audio command. For example, a utility technician may be up a utility pole and have a user device 108 such as a pair of smart glasses with a camera. The utility technician may speak an audio command to the voice-controlled device 102 to provide instruction to fix a particular utility box. The virtual assistant 205 that receives the audio command may provide instructions to the smart glasses to capture an image of the user's view. The virtual assistant 205 may include image recognition system that can identify the utility box that the utility technician is looking at from the captured image provided by the camera of the smart glasses.

The method 500 then proceeds to block 504 where an identity of the user that provided the audio input is determined. In an embodiment of block 504, the user identification engine 210 of the voice-controlled device 200 may determine an identity of the user 106 from the audio signal generated from the audio input 602. In some embodiments, the user identification engine 210 may work with the speech recognition engine 206 to determine a voice print of the user from the audio command, and then compare the voice print to stored voice prints associated with user profiles in the user profile database 220 to determine the identity of the user 106. In other embodiments, the voice-controlled device 102 may provide the voice print of the user 106 to the virtual assistant augmentation server 116, and the virtual assistant augmentation server 116 may determine the identity of the user 106 by comparing the voice print of the user 106 to voice prints associated with user profiles stored in the messaging system database 408. In yet other embodiments, the user identification engine 210 may determine the identity of the first user with data gathered by the identity detection device 226. For example, when the identity detection device 226 is a camera, the user identification engine 210 may utilize facial recognition techniques on images of the first user captured by the camera to determine the identity of the first user. In other examples, the voice-controlled device 102 may initialize a dialogue, via the speaker 224 and microphone 222 to identify and authenticate the user 106 via user credentials provided by the user 106.

In yet another embodiment, the user identification engine 210 may operate with the first communication interface 216 and/or the second communication interface 218 to determine the identity of the user 106. For example, the user profile database 220 may store associations between a user profile and a user device identifier of a user device such as the user devices 108. The user device may be mobile phone, a wearable device, a tablet computing system, a laptop/notebook computing system, an implantable device, and any other user device that has a high probability of only being associated with a particular user or users. The user device identifier may be a token, character, string, or any identifier for differentiating a user device from another user device. For example, the user device identifier may be an internet protocol address, a network address, a media access control (MAC) address, a universally unique identifier (UUID) and/or any other identifier that can be broadcasted from the user device 108 to the voice-controlled device 102. As such, when the user device 108 comes into proximity of a low energy protocol wireless signal provided by the second communication interface 218, a user device identifier associated with the user device 108 may be communicated to the second communication interface 218. The user identification engine 210 may then compare the received user device identifier to user device identifiers that are stored in the user profile database 220 and that are associated with user profiles. If the user device identifier of the user device 108 matches a stored user device identifier associated with a user profile, then the user identification engine 210 may determine there is a high probability that the user 106 of the user device 108 is the user identified in that user profile. In some embodiments, the user identification engine 210 may use a combination of identification techniques described above to obtain a high enough confidence level to associate the user 106 with a stored user profile. While specific embodiments to determine the identity of the user 106 have been described, one of skill in the art in possession of the present disclosure will recognize that the voice-controlled device 102 may determine the identity of the user 106 using other identifying methods without departing from the scope of the present disclosure.

Referring to the specific example illustrated in FIG. 6A and 6B, the user 106 may be in proximity of the voice-controlled device 102 such that the second communication interface 218 of the voice-controlled device 102 receives the wireless signal from the second communication interface 414 of the user device 108. The user device 108 may be a mobile phone that is configured to operate according to a low energy wireless protocol, and the voice-controlled device 102 may detect the user device 108 and receive a user device identifier when the user device 108 transmits/advertises its user device identifier (e.g., to establish a communication session with other devices operating according to the same low energy protocol.) The user identification engine 210 of the voice-controlled device 102 may compare the user device identifier of the user device 108 to user device identifiers associated with user profiles in the user profile database to determine that the user 106 is in proximity to the voice-controlled device 102.

In various embodiments, the identity of the user 106 may be used by the virtual assistant 205 to authenticate the user 106 during the virtual assistant interaction session if any of the tasks during the virtual assistant interaction session require user authentication. For example, if a purchase is being made using the virtual assistant 205, the virtual assistant 205 may use the identity of the user 106 determined by the user identification engine to authenticate the user if authentication is required before making the purchase.

The method 500 then proceeds to block 506 where content factors of content to be provided to a user participating in the virtual assistant interaction session between the user and the virtual assistant is classified. In an embodiment of block 506, the virtual assistant 205 of the voice-controlled device by itself, or a combination of the virtual assistant 205 of the voice-controlled device 102 and the virtual assistant 308 of the virtual assistant augmentation server 116 may determine a response to the audio command received by the virtual assistant 205. Therefore, while the disclosure may describe actions as being performed by the virtual assistant 205, it should be understood that these actions can equally be performed by the virtual assistant 308 or a combination of virtual assistants 205 and 308.

It should be further understood that actions described herein as being performed by the virtual assistant 205 and/or the virtual assistant 308 may equally include actions performed solely by the virtual assistant 205, solely by the virtual assistant 308, a combination of virtual assistants 205 and 308, in conjunction with third party applications or other internet services, or other virtual assistants at the auxiliary device 112 and/or the user device 108, and the like.

As such, the virtual assistant 205 and/or the virtual assistant 308 may determine the response to the audio command. The response may include content to communicate to the user 106. The content may include video content, audio content, audiovisual content, image content, haptic content, olfactory content, and/or any other content that would be apparent to one of skill in the art in possession of the present disclosure.

The virtual assistant 205 and/or 308 may determine one or more responses to provide as a response to the audio command. For example, the virtual assistant 205 and/or 308 may generate a response that only includes audio content. However, in other examples, the virtual assistant 205 and/or 308 may generate a response that includes video content or other type of content. For example, if the audio command of the audio input 602 was a request for a cooking recipe, the virtual assistant 205 and/or 308 may prepare the response to the audio command by providing the requested cooking recipe in the form of audio content. However, the virtual assistant 205 and/or 308 may generate the cooking recipe as an image or as a how-to video to cook the requested dish. In another example, if the audio command of the audio input 602 was a request for directions to a location, the virtual assistant 205 and/or 308 may prepare the response to the audio command by providing the requested directions in the form of audio content. However, the virtual assistant 205 and/or 308 may prepare a response that generates the direction as a visual list, that opens a navigation application that requires a display, and the like. In another example, the audio command may have specifically indicated the type of content with which the virtual assistant 205 and/or 308 is to respond. For example, the audio command may have stated, “Show créme brûllée cooking video.” In other examples, the user profile in the user profile database 220 may indicate preferred content to provide in the response to an audio command.

In an embodiment, the virtual assistant augmentation engine 207 of the voice-controlled device 102 and/or the virtual assistant augmentation engine 306 may classify the content of the one or more responses generated by the virtual assistant 205 and/or the virtual assistant 308. For example, the content may be classified based on one or more content factors. The contact factors may include privacy level (e.g., very private content, personal content, public content, or very public content), on the type of content (e.g., video content, audio content, visual audio content, tactile content, image content, and/or other content or combinations of content that would be apparent to one of skill in the art in possession of the present disclosure), a security level (e.g., high security, low security), authentication (e.g., authenticated or unauthenticated), transactional content versus informational content, and/or other content factors that would be apparent to one of skill in the art in possession of the present disclosure.

The method 500 may then proceed to block 508 where context factors associated with context of the virtual assistant interaction session is determined. In an embodiment of block 508, the virtual assistant augmentation engine 207 and/or the virtual assistant augmentation engine 306 may determine context factors associated with the virtual assistant interaction session. The context factors may include a context of conditions within the physical environment 104 and/or the user 106 in the physical environment 104 during the virtual assistant interaction session. For example, the context factors may include location information of where the virtual assistant interaction session is occurring (e.g., a home, a public space, a vehicle). The context factors may include movement information associated with the user 106, the voice-controlled device 102, the user device 108, and/or the auxiliary device 112 within the physical environment 104. The context factors may also include presence information (e.g., whether the user 106 is accompanied by other users or unaccompanied within the physical environment 104).

In various embodiments, the context factors may be predetermined while other context factors are captured by sensors in the physical environment 104, sensors included in the voice-controlled device 102, sensors included in the user device 108, and/or sensors included in the auxiliary device 112. For example, the location information may be predefined in a voice-controlled device profile stored in the user profile database 220 and/or stored in the virtual assistant augmentation database 312 that defines the location information as a home location, a vehicle location, an office location, a general public location, a general private location, a park location, a museum location, and/or any other type of location information that would be apparent to one of skill in the art in possession of the present disclosure. In other examples, the location information may be a geophysical location provided by the positioning system 219 housed in the chassis 202 of the voice-controlled device 102 that may include sensors for determining the location and position of the voice-controlled device 102 within the physical environment 104.

With respect to the movement information, motion sensors in the physical environment 104, motion sensors included in the voice-controlled device 102, motion sensors included in the user device 108, and/or motion sensors included in the auxiliary device 112 may be used to detect movement of the user 106. In one example, the motion sensor may be used such as a passive infrared sensor. However, other sensors may be used to determine motion information. For example, the voice-controlled device 102 may include a plurality of microphones 222 and/or may operate in conjunction with the microphones of the user device 108 and/or the auxiliary device 112 to capture an audio signal based on sound generated from the user 106. In these instances, the user location engine 212 may utilize time-difference-of-arrival (TDOA) techniques to determine a distance of the user 106 is from the voice-controlled device 102 and/or user device 108/auxiliary device 112. The user location engine 212 may then cross-correlate the times at which different microphones received the audio to determine a location of the user 106. The user location engine 212 may perform this over time to determine a movement of the user 106 within the physical environment 104. In another example, the user location engine 212 may analyze the audio signal to detect the doppler effect or change in frequency in the audio input to determine whether the user is moving away or towards the voice-controlled device 102.

In another example, the voice-controlled device 102 may include the identity detection device 226 such as a camera that captures images of the physical environment 104 surrounding the voice-controlled device 102. The user location engine 212 may then analyze these images to identify a location of the user 106 and movement of the user 106. In yet other examples, the user location engine 212 may receive wireless communication signals at the first communication interface 216 and/or the second communication interface 218 from the user device 108 that is associated with the user 106. Based on changes in signal strength of those wireless communication signals, the user location engine 212 may detect movement of the user 106. While specific examples of determining movement of a user or users within an environment are described, one of skill in the art in possession of the present disclosure will recognize that other motion detection and tracking techniques would fall under the scope of the present disclosure.

With respect to the presence information, presence sensors in the physical environment 104, presence sensors included in the voice-controlled device 102, presence sensors included in the user device 108, and/or presence sensors included in the auxiliary device 112 may be used to detect whether the user 106 is alone or accompanied by another person within the physical environment 104. For example, the speech recognition engine 206 may analyze the audio signals received from the environment to determine whether other voice signatures are present in the audio signal other than the user's 106 voice signature. In another example, the voice-controlled device 102 may include the identity detection device 226 such as a camera that captures images of the physical environment 104 surrounding the voice-controlled device 102. The user location engine 212 may then analyze these images to identify other users within the physical environment 104. In yet another example, the user location engine 212 may receive wireless communication signals at the first communication interface 216 and/or the second communication interface 218 from the user devices other than the user device 108 that is associated with the user 106, which may indicate that another person is within the physical environment 104. While specific context factors are described, one of skill in the art in possession of the present disclosure will recognize that other context factors about the physical environment 104 and the user 106 would fall under the scope of the present disclosure.

The method 500 may then proceed to block 510 where at least one computing device coupled to the voice-controlled device is identified. In an embodiment of block 510 the virtual assistant augmentation engine 207 and/or the virtual assistant augmentation engine 306 may detect a user device 108 and/or an auxiliary device 112 within the physical environment 104 that may supplement a virtual assistant interaction session with the voice-controlled device 102. Each of the user device 108 and/or the auxiliary device 112 may include the virtual assistant augmentation application 404. When powered on and the virtual assistant augmentation application 404 is running, the user device 108 and/or the auxiliary device 112 may communicate its device capabilities to the virtual assistant augmentation engine 207 of the voice-controlled device 102 and/or the virtual assistant augmentation engine 306 of the virtual assistant augmentation server 116 via the first communication interface 412 and/or the second communication interface 414 of the user device 108 and/or the auxiliary device 112. The device capabilities may include the type of computing device, input/output device capabilities (e.g., whether there is a display system 422, characteristics of the display system 422 (e.g., a display screen size), information associated with the user input subsystem 420, whether there is an audio system that includes the microphone 424 and speaker 426, etc.), applications (e.g. a navigation application, a web browser application, etc.) installed on the user device 108 and/or the auxiliary device 112 and/or any other device capabilities that would be apparent to one of skill in the art in possession of the present disclosure.

The method 500 may then proceed to block 512 where at least a portion of the content is transitioned to a computing device of the at least one computing device, in response to the content factors, the context factors, and the respective device capabilities of each at least one computing device satisfying a first augmentation condition. In an embodiment of block 512 the virtual assistant augmentation engine 207 and/or the virtual assistant augmentation engine 306 may determine where the content or a portion of the content of the response to the audio command is to be provided to the user 106. In an embodiment of block 512, the virtual assistant augmentation engine 207 and/or the virtual assistant augmentation engine 306 may include a set of rules that manage where the content of the response is to be presented. The rules may be predefined by the service provider of the virtual assistant augmentation engines 207 and/or 306, and/or by the user 106 that defines rules in the user profile of the user 106 that is stored in the user profile database 220 and/or the virtual assistant augmentation database 312. In other embodiments, the rules may be dynamic in that the virtual assistant augmentation engine 207 and/or the virtual assistant augmentation engine 306 may include machine learning algorithms such as, for example, frequent pattern growth heuristics, other unsupervised learning algorithms, supervised learning algorithms, semi-supervised learning algorithms, reinforcement learning algorithms, deep learning algorithms, and other machine learning algorithms apparent to one of skill in the art in possession of the present disclosure that dynamically update the rules for presenting content of a response to the audio command of the user 106.

The rules may be configured to use the context factors, content factors, and device capabilities of the user device 108 and/or the auxiliary device 112 within the physical environment 104 to augment the virtual assistant interaction session at the voice-controlled device 102 by presenting at least a portion of the content of the response to the audio command to the user 106 via the user device 108 and/or the auxiliary device 112. In an example and referring to the virtual assistant augmentation system 600 of FIG. 6A, the audio input 602 may include an audio command requesting a recipe for cooking a dish. As discussed above in block 506, the virtual assistant 205 and/or 308 may determine the content for the response to the audio command is best presented as a visual list of steps for the recipe rather than listing the steps out to the user 106 in an audio response to the audio command via the voice-controlled device 102. The virtual assistant augmentation engine 207 and/or 306 may determine the content factors associated with the content. For example, the virtual assistant augmentation engine 207 and/or 306 may determine that the visual recipe content is public content, the content is informational rather than transactional, the content is highly visual content, the content requires no authentication and is of low security.

The virtual assistant augmentation engine 207 and/or 306 may then determine the context factors associated with the physical environment 104. For example, the virtual assistant augmentation engine 207 and/or 306 may determine that the physical environment 104 is a home location, the user 106 is substantially stationary (e.g., moving with a predetermined range), and the user 106 is accompanied by other people. The virtual assistant augmentation engine 207 and/or 306 may determine the device capabilities of the devices within the physical environment 104. For example, the virtual assistant augmentation engine 207 and/or 306 may determine that there is the auxiliary device 112 that may be a microwave that includes a display system 422 but lacks a speaker 426 and the user device 108 that may be provided by a mobile phone that include the display system 422, the microphone 424, and the speaker 426. Because the content factors indicate that the visual recipe content is public, has low security, is informational, and unauthenticated, the context factors indicate that the virtual assistant interaction session is at a home location, accompanied by other people, and the user is stationary, and the device capabilities indicate that there is a microwave that has a display device, then the virtual assistant augmentation engine 207 and/or 306 may determine to provide the content (e.g., content 612) of the recipe on the auxiliary device 112 that is the microwave in the kitchen of the physical environment 104.

In various embodiments, the content 612 may be displayed via a graphical user interface of an application 610. The application 610 may be the virtual assistant augmentation application 404. In other examples, the application 610 may be provided by a third-party application such as a web browser launched by the virtual assistant augmentation application 404. The virtual assistant 205 and/or 308 may communicate, via the network 110 and/or through a direct communication via the second communication interface 218, the content or a location of the content from which the virtual assistant augmentation application 404 can retrieve the content. In doing so, the virtual assistant augmentation engine 207 and/or 306 may maintain the virtual assistant interaction session at the voice-controlled device 102 and/or at the virtual assistant augmentation server as a parent virtual assistant interaction session and generate at the virtual assistant augmentation application 404 a child virtual assistant interaction session. Therefore, inputs from the user 106 for the virtual assistant interaction session may be captured at the auxiliary device 112 as well as the voice-controlled device 102. When the child virtual assistant interaction session portion has completed at the auxiliary device 112, the virtual assistant interaction session may revert completely back to the parent virtual assistant interaction session. However, in other embodiments the virtual assistant interaction session may completely transfer to the auxiliary device 112 based on the context factors, content factors, and the device capabilities when providing the content at the auxiliary device 112. Once the virtual assistant interaction session completes the display of the content at the auxiliary device 112, the virtual assistant interaction session may transfer back to the voice-controlled device 102.

In other examples where the context factors indicate that the user 106 is in motion, the virtual assistant interaction session at the voice-controlled device 102 may transfer to another voice-controlled device. For example, if the virtual assistant augmentation engine 207 and/or 306 determines that the user 106 has moved from the house to a car that includes a voice-controlled device, then the virtual assistant augmentation engine 207 and/or 306 may transfer, via the network 110, the virtual assistant interaction session from the voice-controlled device 102 to the voice-controlled device provided in the car.

Referring to the example virtual assistant augmentation system 600 of FIG. 6B as an alternative to example in FIG. 6A, the audio input 602 may include an audio command requesting payment of a utility bill. As discussed above in block 506, the virtual assistant 205 and/or 308 may determine the content for the response to the audio command is best presented as a visual image of the utility bill rather than describing the information in the utility bill to the user 106 in an audio response to the audio command via the voice-controlled device 102. The virtual assistant augmentation engine 207 and/or 306 may determine the content factors associated with the content. For example, the virtual assistant augmentation engine 207 and/or 306 may determine that the utility bill is private content, the content is transactional, the content is highly visual, the content requires authentication and is of low security. The virtual assistant augmentation engine 207 and/or 306 may determine the context factors associated with the physical environment 104. For example, the virtual assistant augmentation engine 207 and/or 306 may determine that the physical environment 104 is a home location, the user 106 is essentially stationary, and the user 106 is accompanied by other people. The virtual assistant augmentation engine 207 and/or 306 may determine the device capabilities of the devices within the physical environment 104. For example, the virtual assistant augmentation engine 207 and/or 306 may determine that there is the auxiliary device 112 that may be a television that includes a display system 422 and the user device 108 that may be provided by a mobile phone that includes the display system 422, the microphone 424, and the speaker 426. Because the visual content of the utility bill is classified as private, low security, transactional, and requires authentication and the context factors indicate that the virtual assistant interaction session is at a home location, accompanied by other people, and the user 106 is stationary and there is a television (auxiliary device 112) that has a display device and a mobile phone (the user device 108) that is associated with the user 106, then the virtual assistant augmentation engine 207 and/or 306 may determine to provide the content (e.g., content 612) of the utility bill on the user device 108 that is the mobile phone over the auxiliary device that is a television to prevent the utility bill from being visible to the other people that are in the physical environment 104.

In various embodiments, the content 612 may be displayed via a graphical user interface of an application 610. The application 610 may be the virtual assistant augmentation application 404. In other examples, the application 610 may be provided by a third-party application such as a web browser or a bill pay application associated with the utility bill launched by the virtual assistant augmentation application 404. The virtual assistant 205 and/or 308 may communicate, via the network 110 and/or through a direct communication via the second communication interface 218, the content or a location of the content from which the virtual assistant augmentation application 404 can retrieve the content. In doing so, the virtual assistant augmentation engine 207 and/or 306 may maintain the virtual assistant interaction session at the voice-controlled device 102 and/or at the virtual assistant augmentation server as a parent virtual assistant interaction session and generate at the virtual assistant augmentation application 404 a child virtual assistant augmentation session. Therefore, inputs from the user 106 for the virtual assistant interaction session may be captured at the user device 108 as well as the voice-controlled device 102. When the child virtual assistant interaction session portion has completed at the user device 108, the virtual assistant interaction session may revert completely back to the parent virtual assistant interaction session at the voice-controlled device 102.

In other embodiments, the virtual assistant augmentation engine 207 and/or 306 may generate a plurality of child virtual assistant interaction session. For example, the user 106 may require support from the utility company in completing the transaction. The virtual assistant augmentation engine 207 and/or 306 may generate a child virtual interaction session that may allow an authorized third-party to participate in the virtual assistant interaction session. The virtual assistant augmentation engine 207 and/or 306 may initiate the additional child session at another user device such as a customer support terminal where an additional user (e.g., a support representative for the utility company) can participate in the virtual assistant interaction session.

In yet other embodiments, the auxiliary device 112 and/or the user device 108 may be used to remind the user 106 of incomplete virtual assistant interaction sessions with the voice-controlled device 102. For example, the user 106 may be participating in a virtual assistant interaction session at the voice-controlled device 102. The user 106 may be interrupted or otherwise leave the virtual assistant interaction session at the voice-controlled device 102. For example, the user 106 may receive a phone call at the user device 108 and stop participating with the virtual assistant interaction session at the voice-controlled device 102. Once the phone call is completed, the user device 108 may remind the user 106 of the virtual assistant interaction session at the voice-controlled device 102 (e.g., change color of lighting in room, seat vibration, send notification to the auxiliary device 112 and/or user device 108, etc). In other examples, the user 106 may provide an audio command to the virtual assistant 205 to remind the user 106 to complete a step in a process that the user 106 is participating in while interacting with the virtual assistant 205. The virtual assistant augmentation engine 207 may remind the user 106 of the step to be completed using the auxiliary device 112 and/or the user device 108 to provide a notification to the user 106 after a predetermined amount of time has passed or when a predefined condition is satisfied.

Thus, systems and methods have been described that provide for a virtual assistant augmentation system. The virtual assistant augmentation system and methods provide for presenting content of a virtual assistant interaction session to a user via an output interface on a computing device other than a voice-controlled device with which the virtual assistant interaction is initiated that is better able to provide the content than the output interface(s) that are included on the voice-controlled device. The virtual assistant interaction session is augmented based on content factors associated with the content that is to be presented to the user, context factors associated with the physical environment in which the voice-controlled device is located and/or the user, and device capabilities of computer devices that may be used as auxiliary devices in conducting the virtual assistant interaction session that provide alternative output interfaces for the content.

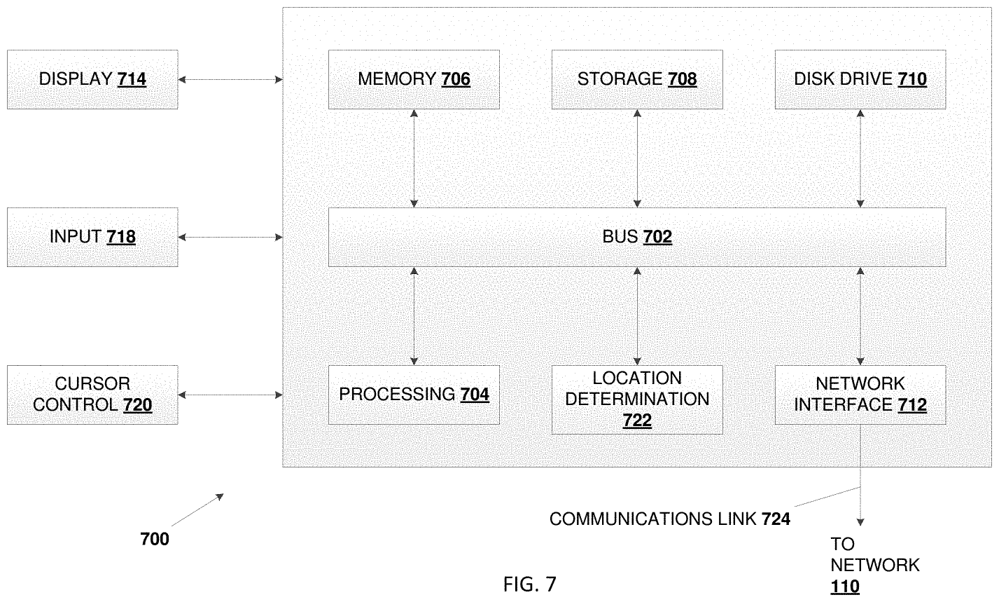

Referring now to FIG. 7, an embodiment of a computer system 700 suitable for implementing, for example, the user devices 108, the voice-controlled device 102, virtual assistant augmentation server 116, and/or auxiliary device 112, is illustrated. It should be appreciated that other devices utilized by users, and messaging service providers in the audio communication system discussed above may be implemented as the computer system 700 in a manner as follows.

In accordance with various embodiments of the present disclosure, computer system 700, such as a computer and/or a network server, includes a bus 702 or other communication mechanism for communicating information, which interconnects subsystems and components, such as a processing component 704 (e.g., processor, micro-controller, digital signal processor (DSP), etc.), a system memory component 706 (e.g., RAM), a static storage component 708 (e.g., ROM), a disk drive component 710 (e.g., magnetic or optical), a network interface component 712 (e.g., modem or Ethernet card), a display component 714 (e.g., CRT or LCD), an input component 718 (e.g., keyboard, keypad, or virtual keyboard), a cursor control component 720 (e.g., mouse, pointer, or trackball), and/or a location determination component 722 (e.g., a Global Positioning System (GPS) device as illustrated, a cell tower triangulation device, and/or a variety of other location determination devices.) In one implementation, the disk drive component 710 may comprise a database having one or more disk drive components.

In accordance with embodiments of the present disclosure, the computer system 700 performs specific operations by the processing component 704 executing one or more sequences of instructions contained in the system memory component 706, such as described herein with respect to the drone(s), the drone docking station(s), the service platform, and/or the remote monitor(s). Such instructions may be read into the system memory component 706 from another computer-readable medium, such as the static storage component 708 or the disk drive component 710. In other embodiments, hardwired circuitry may be used in place of or in combination with software instructions to implement the present disclosure.

Logic may be encoded in a computer-readable medium, which may refer to any medium that participates in providing instructions to the processing component 704 for execution. Such a medium may take many forms, including but not limited to, non-volatile media, volatile media, and tangible media employed incident to a transmission. In various embodiments, the computer-readable medium is non-transitory. In various implementations, non-volatile media includes optical or magnetic disks and flash memory, such as the disk drive component 710, volatile media includes dynamic memory, such as the system memory component 706, and tangible media employed incident to a transmission includes coaxial cables, copper wire, and fiber optics, including wires that comprise the bus 702 together with buffer and driver circuits incident thereto.

Some common forms of computer-readable media include, for example, floppy disk, flexible disk, hard disk, magnetic tape, any other magnetic medium, CD-ROM, DVD-ROM, any other optical medium, any other physical medium with patterns of holes, RAM, PROM, EPROM, FLASH-EPROM, any other memory chip or cartridge, cloud storage, or any other medium from which a computer is adapted to read. In various embodiments, the computer-readable media are non-transitory.

In various embodiments of the present disclosure, execution of instruction sequences to practice the present disclosure may be performed by the computer system 700. In various other embodiments of the present disclosure, a plurality of the computer systems 700 coupled by a communication link 724 to a communication network 110 (e.g., such as a LAN, WLAN, PTSN, and/or various other wired or wireless networks, including telecommunications, mobile, and cellular phone networks) may perform instruction sequences to practice the present disclosure in coordination with one another.

The computer system 700 may transmit and receive messages, data, information and instructions, including one or more programs (e.g., application code) through the communication link 724 and the network interface component 712. The network interface component 712 may include an antenna, either separate or integrated, to enable transmission and reception via the communication link 724. Received program code may be executed by processor 704 as received and/or stored in disk drive component 710 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components, and vice versa.

Software, in accordance with the present disclosure, such as program code or data, may be stored on one or more computer-readable media. It is also contemplated that software identified herein may be implemented using one or more general-purpose or special-purpose computers and/or computer systems, networked and/or otherwise. Where applicable, the ordering of various steps described herein may be changed, combined into composite steps, and/or separated into sub-steps to provide features described herein.

The foregoing is not intended to limit the present disclosure to the precise forms or particular fields of use disclosed. As such, it is contemplated that various alternate embodiments and/or modifications to the present disclosure, whether explicitly described or implied herein, are possible. Persons of ordinary skill in the art in possession of the present disclosure will recognize that changes may be made in form and detail without departing from the scope of what is claimed.

What is claimed is:

1. A method of virtual assistant augmentation, comprising:
determining content factors of content to be presented to a user participating in a virtual assistant interaction session between the user and a virtual assistant provided through a voice-controlled device;
determining context factors associated with a physical environment in which the voice-controlled device and the user are located;
identifying at least one computing device coupled to the voice-controlled device, wherein each of the at least one computing device provides a respective device capability; and
in response to the content factors, the context factors, and the respective device capabilities of each at least one computing device satisfying a first virtual assistant augmentation condition, transitioning at least a portion of the content of the virtual assistant interaction session to a first computing device of the at least one computing device.

2. The method of claim 1, further comprising:
in response to the content factors, the context factors, and the respective device capabilities of each at least one computing device satisfying a second augmentation condition, transitioning the virtual assistant interaction session to a second computing device of the at least one computing device.

3. The method of claim 1, further comprising:
transitioning the virtual assistant interaction session back to the voice-controlled device in response to completion of the at least the portion of the virtual assistant interaction session at the first computing device.

4. The method of claim 1, further comprising:
predicting, using a machine learning algorithm, acceptable transitions between the voice-controlled device and the first computing device of the at least one computing device.

5. The method of claim 1, further comprising:
determining that the virtual assistant interaction session is interrupted; and
providing a reminder by the first computing device of the at least one computing device that the virtual assistant interaction session is incomplete.

6. The method of claim 1, wherein the voice-controlled device does not include an output device that is configured to service the at least the portion of the content.

7. The method of claim 1, wherein the content factors include at least one of a privacy level, a content type, a security level, an authentication requirement, and informational context of the content.

8. The method of claim 1, wherein the context factors include at least one of location information of the voice-controlled device, movement information of the user within the physical environment, and presence information of additional users.

9. The method of claim 1, further comprising:
receiving an audio input at the voice-controlled device that includes an audio command that initiates the virtual assistant interaction session.

10. The method of claim 1, further comprising:
identifying the user participating in the virtual assistant interaction session, wherein the first virtual assistant augmentation condition is based on an identity of the user.

11. A system comprising:
a non-transitory memory; and
one or more hardware processors coupled to the non-transitory memory and configured to read instructions from the non-transitory memory to cause the system to perform operations comprising:
determining content factors of content to be presented to a user participating in a virtual assistant interaction session between the user and a virtual assistant provided through a voice-controlled device;
determining context factors associated with a physical environment in which the voice-controlled device and the user are located;
identifying at least one computing device coupled to the voice-controlled device, wherein each of the at least one computing device provides a respective device capability; and
in response to the content factors, the context factors, and the respective device capabilities of each at least one computing device satisfying a first virtual assistant augmentation condition, transitioning at least a portion of the content of the virtual assistant interaction session to a first computing device of the at least one computing device.

12. The system of claim 11, wherein the operations further comprise:
in response to the content factors, the context factors, and the respective computing device capabilities of each at least one device satisfying a second augmentation condition, transitioning the virtual assistant interaction session to a second computing device of the at least one computing device.

13. The system of claim 11, wherein the operations further comprise:
transitioning the virtual assistant interaction session back to the voice-controlled device in response to completion of the at least the portion of the virtual assistant interaction session at the first computing device.

14. The system of claim 11, wherein the operations further comprise:
predicting, using a machine learning algorithm, acceptable transitions between the voice-controlled device and the first computing device of the at least one computing device.

15. The system of claim 11, wherein the operations further comprise:
determining that the virtual assistant interaction session is interrupted; and
providing a reminder by the first computing device that the virtual assistant interaction session is incomplete.

16. A non-transitory machine-readable medium having stored thereon machine-readable instructions executable to cause a machine to perform operations comprising:
determining content factors of content to be presented to a user participating in a virtual assistant interaction session between the user and a virtual assistant provided through a voice-controlled device;
determining context factors associated with a physical environment in which the voice-controlled device and the user are located;
identifying at least one computing device coupled to the voice-controlled device, wherein each of the at least one computing device provides a respective device capability; and
in response to the content factors, the context factors, and the respective device capabilities of each at least one computing device satisfying a first virtual assistant augmentation condition, transitioning at least a portion of the content of the virtual assistant interaction session to a first computing device of the at least one computing device.

17. The non-transitory machine-readable medium of claim 16, wherein the operations further comprise:
in response to the content factors, the context factors, and the respective computing device capabilities of each at least one device satisfying a second augmentation condition, transitioning the virtual assistant interaction session to a second computing device of the at least one computing device.

18. The non-transitory machine-readable medium of claim 16, wherein the operations further comprise:
transitioning the virtual assistant interaction session back to the voice-controlled device in response to completion of the at least the portion of the virtual assistant interaction session at the first computing device.

19. The non-transitory machine-readable medium of claim 16, wherein the operations further comprise:
predicting, using a machine learning algorithm, acceptable transitions between the voice-controlled device and the first computing device of the at least one computing device.

20. The non-transitory machine-readable medium of claim 16, wherein the operations further comprise:
determining that the virtual assistant interaction session is interrupted; and
providing a reminder by the first computing device that the virtual assistant interaction session is incomplete.
